(19) United States
(12) Patent Application Publication
(10) Pub. No.: US 2008/0081121 A1
(43) Pub. Date: Apr. 3, 2008

(54) COMPOSITION, FILM AND FORMATION PROCESS THEREOF

(75) Inventors: Kensuke MORITA, Haibara-gun (JP); Haruki INABE, Haibara-gun (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 11/858,644

(22) Filed: Sep. 20, 2007

(30) Foreign Application Priority Data
Sep. 21, 2006 (JP) 2006-255848

(51) Int. Cl. C08F 30/08; B05D 3/02

(52) U.S. Cl. 427/387; 526/279

(57) ABSTRACT

A composition includes at least one kind polymer, each of which includes a repeating unit(s) derived from at least one compound selected from the group consisting of compounds represented by the following formulas (I) to (IV):
R₄Si (I)
R₃Si—(X—SiR₂)ₘ—X—Si—R₃ (II)
*—(X—SiR₂)ₙ—* (III)
m.RSi(O_{0.5})₃ (IV) wherein the symbols in the formulas are defined in the specification.

### BACKGROUND OF THE INVENTION

1. Field of the Invention

The present invention relates to a film forming composition, more specifically, a composition for forming an insulating film used for electronic devices and excellent in film properties such as dielectric constant, etch selectivity, metal diffusion barrier properties, mechanical strength and heat resistance. Moreover, the invention pertains to an insulating film available by using the composition and an electronic device having the insulating film.

2. Description of the Related Art

In recent years, with the progress of high integration, multifunction and high performance in the field of electronic materials, circuit resistance and condenser capacity between interconnects have increased and have caused an increase in electric power consumption and delay time. Particularly, the increase in delay time becomes a large factor for reducing the signal speed of devices and generating crosstalk. Reduction of parasitic resistance and parasitic capacity are therefore required in order to reduce this delay time, thereby attaining speed-up of devices. As one of the concrete measures for reducing this parasitic capacity, an attempt has been made to cover the periphery of an interconnect with a low dielectric interlayer insulating film (specific dielectric constant: 3.0 or less).

When a semiconductor device is manufactured, it is necessary that a metal (copper or the like) used for an interconnect does not diffuse in an insulating film even by heating at about 400° C. Typical low-k (low dielectric constant) insulating films have no diffusion barrier properties against an interconnect metal so that an insulating barrier film is placed between the insulating film and the metal in order to avoid diffusion of the metal into the insulating film. For patterning of a low-k insulating film by etching, an etching stopper film is employed. Silicon nitride, silicon carbide and the like are employed as such an etching stopper film, but their specific dielectric constant is typically as high as 4.0 or greater and becomes a cause for increasing an effective dielectric constant of an interlayer insulating film. An etching stopper film made of an organosilicon polymer and having a specific dielectric constant of 4 or less is proposed in JP-A-2004-186610 (the term “JP-A” as used herein means an “unexamined published Japanese patent application”). A composition having a sufficiently small metal content was not obtained by the process described in this patent, because a metal compound was used for preparation of the polymer. In addition, the composition had an insufficient specific dielectric constant.

There is accordingly a demand for the development of an insulating film having a small specific dielectric constant, a high etch selectivity to a low-k film, high effects for preventing metal diffusion, and a small metal content.

### SUMMARY OF THE INVENTION

The present invention therefore relates to a composition for overcoming the above-described problems, a film formation process and a film formed using the process. More specifically, an object of the invention is to provide a composition capable of forming an insulating film suited for use as an interlayer insulating film in semiconductor devices and the like, having an adequately uniform thickness, excellent in film properties such as dielectric constant and Young's modulus, and excellent in etch selectivity and metal diffusion barrier properties; a film formation process using the composition, a film obtained using the forming process, and a semiconductor device having the film. An “insulating film” is also referred to as a “dielectric film” or a “dielectric insulating film”, and these terms are not substantially distinguished.

It has been found that the above-described objects can be accomplished by the following means.

(1) A composition comprising:

at least one kind polymer, each of which comprises a repeating unit(s) derived from at least one compound selected from the group consisting of compounds represented by the following formulas (I) to (IV):
R₄Si (I)

wherein each of Rs represents a nonhydrolyzable group, with the proviso that each of at least two of Rs represents a group comprising vinyl group or ethynyl group;
R₃Si—(X—SiR₂)ₘ—X—Si—R₃ (II)

wherein each of Rs represents a nonhydrolyzable group, with the proviso that each of at least two of Rs represents a group comprising vinyl group or ethynyl group,

m represents an integer of 0 or greater, and

X represents —O—, —NR¹—, an alkylene group or a phenylene group in which R¹ represents a hydrogen atom or a substituent;
*—(X—SiR₂)ₙ—* (III)

wherein each of Rs represents a nonhydrolyzable group, with the proviso that each of at least two of Rs represents a group comprising vinyl group or ethynyl group,

X represents —O—, —NR¹—, an alkylene group or a phenylene group in which R¹ represents a hydrogen atom or a substituent,

n represents an integer of 2 to 16, and

*s are bonded to each other to form a ring; and
m.RSi(O_{0.5})₃ (IV)

wherein the formula (IV) represents a compound that has m pieces of RSi(O_{0.5})₃ units, each of which links with other units by sharing the oxygen atoms so as to form a cage structure,

m represents an integer of 8 to 16,

each of Rs represents a nonhydrolyzable group, with the proviso that each of at least two of Rs represents a group comprising vinyl group or ethynyl group.

(2) The composition as described in (1),

wherein each of at least two of Rs in each of the formulas (I) to (IV) represents a vinyl group.

(3) The composition as described in (1),

wherein an amount of a polymer which is obtained by reaction between vinyl groups is 60 mass % or greater of solid components in the composition.

(4) The composition as described in (1),

wherein the at least one kind polymer comprises a polymer which is obtained by radical polymerization.

(5) The composition as described in (1), which is soluble in an organic solvent.

(6) The composition as described in (1), further comprising: an organic solvent.

(7) The composition as described in (1), further comprising: a surfactant.

(8) A film forming composition, comprising:

the composition as described in (1).

(9) An insulating film forming composition, comprising:

the composition as described in (1).

(10) An etching stopper film forming composition, comprising:

the composition as described in (1).

(11) A metal diffusion barrier film forming composition, comprising:

the composition as described in (1).

(12) A production method of film, comprising:

a process of applying the film forming composition as described in (8) onto a substrate;

a process of film-hardening.

(13) A film produced by the production method as described in (12).

(14) A semiconductor device comprising: the film as described in (13).

### DETAILED DESCRIPTION OF THE INVENTION

The present invention will hereinafter be described specifically.

The composition of the invention contains a polymerization product of at least any of compounds represented by the following formulas (I) to (IV) (which may hereinafter be called “Compounds (I) to (IV)”).
R₄Si (I)
(in the formula (1), Rs each represents a nonhydrolyzable group, with the proviso that at least two of Rs represent a vinyl- or ethynyl-containing group).
R₃Si—(X—SiR₂)ₘ—X—Si—R₃ (II)
(in the formula (II), Rs each represents a nonhydrolyzable group, with the proviso that at least two of Rs represent a vinyl- or ethynyl-containing group, m stands for an integer of 0 or greater, X represents —O—, —NR¹—, an alkylene group or a phenylene group in which R¹ represents a hydrogen atom or a substituent).
*—(X—SiR₂)ₙ—* (III)
(in the formula (III), Rs each represents a nonhydrolyzable group, with the proviso that at least two of Rs each represents a vinyl- or ethynyl-containing group, X represents —O—, —NR¹—, an alkylene group or a phenylene group in which R¹ represents a hydrogen atom or a substituent, n stands for an integer from 2 to 16, and *s are coupled to each other to form a ring).
m.RSi(O_{0.5})₃ (IV)
which formula (IV) has m pieces of RSi((O_{0.5})₃ units, each of the units representing a compound that forms a cage structure by linking with another unit, while having the oxygen atom in common, m stands for an integer from 8 to 16, Rs each represents a nonhydrolyzable group with the proviso that at least two of Rs each represents a vinyl- or ethynyl-containing group).

In Compounds (I) to (IV), Rs each independently represents a nonhydrolyzable group.

The term “nonhydrolyzable group” as used herein means a group whose remaining ratio is 95% or greater, preferably 99% or greater when the group is brought into contact with one equivalent of neutral water at room temperature for one hour.

Examples of the nonhydrolyzable group as R include alkyl groups (such as methyl, t-butyl, cyclopentyl and cyclohexyl), aryl groups (such as phenyl, 1-naphthyl and 2-naphthyl), vinyl group, ethynyl group, allyl group, and silyloxy groups (such as trimethylsilyloxy, triethylsilyloxy and t-butyldimethylsilyloxy). Of these, methyl, phenyl, vinyl and ethynyl groups are preferred.

At least two of the groups represented by R are each a vinyl- or ethynyl-containing group. At least half of the groups represented by R are each preferably a vinyl- or ethynyl-containing group.

When the group represented by R contains a vinyl or ethynyl group, the vinyl or ethynyl group is preferably bonded, directly or via a divalent linking group, to a silicon atom to which the R is bonded. Examples of the divalent linking group include —[C(R¹¹)(R¹²)]ₖ—, —CO—, —O—, —N(R¹³)—, —S—, —O—Si(R¹⁴)(R¹⁵)—, and divalent linking groups available by using them in any combination (R¹¹ to R¹⁵ each independently represents a hydrogen atom, a methyl group, or an ethyl group, and k stands for an integer from 1 to 6). Of these, —[C(R¹¹)(R¹²)]ₖ—, —O—, and —O—Si(R¹⁴)(R¹⁵)— and divalent linking groups available using them in any combination are preferred.

The vinyl or ethynyl group is preferably bonded directly to a silicon atom to which R is bonded.

It is more preferred that at least two vinyl groups of Rs in Compounds (I) to (IV) are directly bonded to a silicon atom to which R is bonded and it is especially preferred that at least half of Rs in Compounds (I) to (IV) are vinyl groups.

In Compounds (II) and (III), R¹ represents a hydrogen atom or a substituent, with a hydrogen atom, methyl group or phenyl group being preferred.

In Compound (II), m stands for an integer of 0 or greater, preferably from 0 to 4, more preferably from 0 to 2. It is also preferred that m stands for an integer of 10 or greater.

In Compound (III), n stands for an integer of from 2 to 16, preferably from 3 to 6, more preferably 3 or 4.

Of Compounds (I) to (IV), Compounds (III) and (IV) are preferred.

Specific examples of Compounds (I) to (IV) include, but are not limited to, the following compounds.

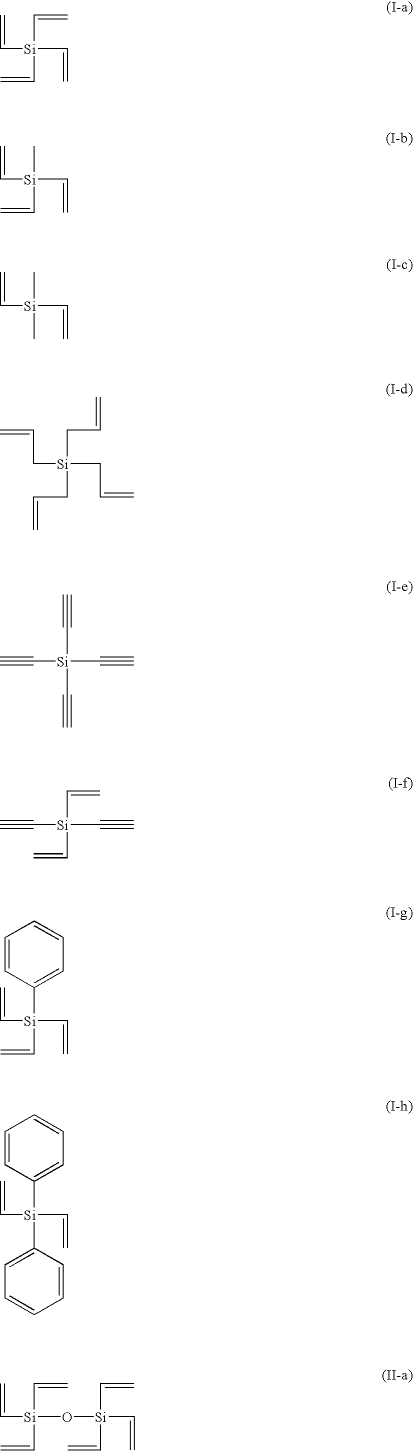

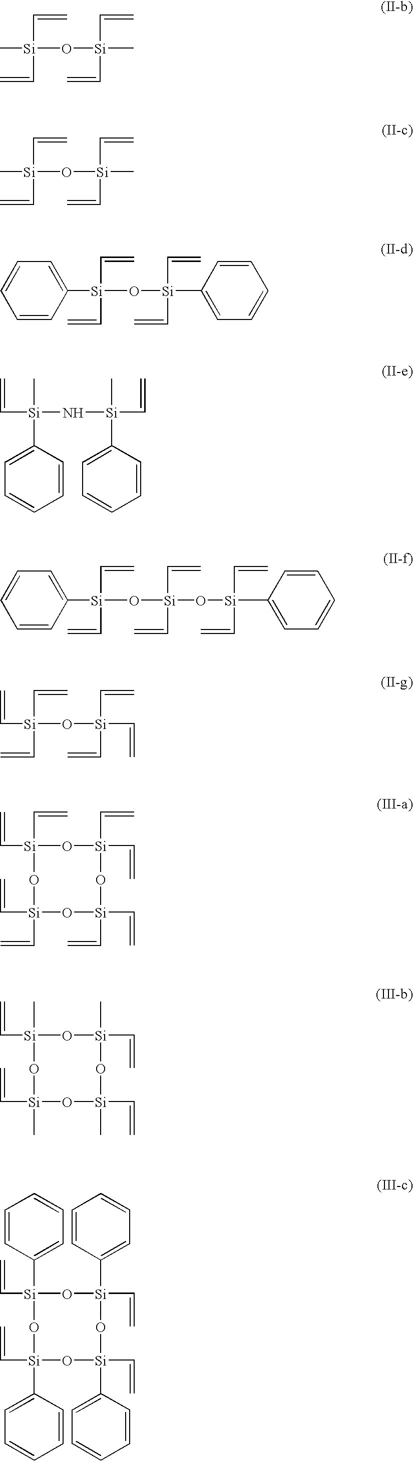

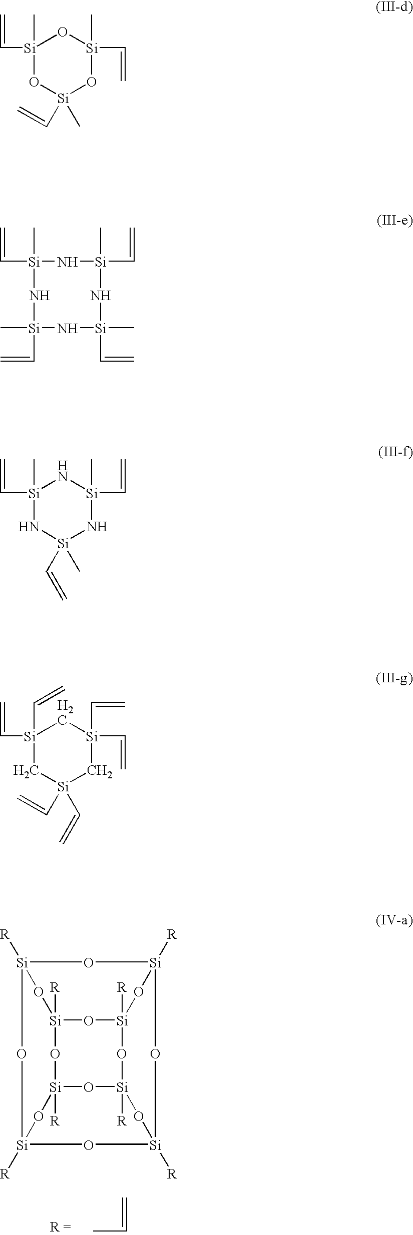

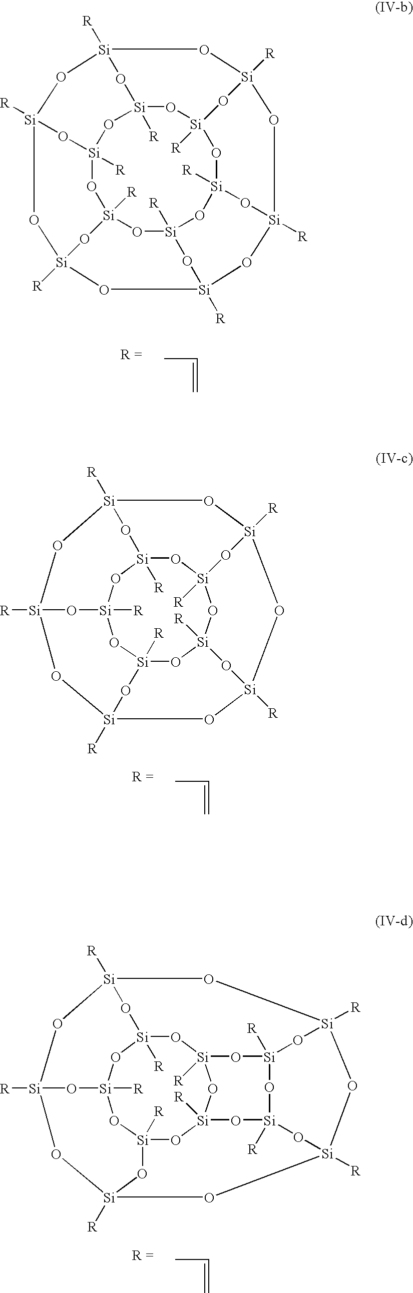

As Compounds (I) to (IV), commercially available ones or those synthesized in a known manner may be used.

The composition of the invention may contain a plurality of different compounds selected from Compounds (I) to (IV) or a polymerization product of them. In this case, the composition may contain a copolymer composed of a plurality of different compounds selected from Compounds (I) to (IV) or a mixture of homopolymers.

The polymerization product of at least any of Compounds (I) to (IV) contained in the composition of the invention may be a copolymerization product with a compound (copolymeric component) other than compounds selected from Compounds (I) to (IV). The compound (copolymeric component) to be used for this purpose is preferably a compound having a plurality of polymerizable carbon-carbon unsaturated bonds or SiH-groups. Preferred examples of the compound include vinylsilanes, vinylsiloxanes, phenylacetylenes and [(HSiO_{0.5})₃]₈.

The composition of the invention may be a solution of a reaction product (polymerization product) of a compound selected from Compounds (I) to (IV) dissolved in an organic solvent or may be a solid containing a reaction product (polymerization product) of a compound selected from Compounds (I) to (IV).

The composition of the invention is prepared preferably by subjecting a compound selected from Compounds (I) to (IV) to a hydrosilylation reaction or a polymerization reaction of carbon-carbon unsaturated bonds.

It is especially preferred to dissolve a compound selected from Compounds (I) to (IV) in a solvent and adding a polymerization initiator to the resulting solution to cause a reaction with the vinyl or ethynyl group.

Any polymerization reaction can be employed and examples include radical polymerization, cationic polymerization, anionic polymerization, ring-opening polymerization, polycondensation, polyaddition, addition condensation and polymerization in the presence of a transition metal catalyst.

The polymerization reaction of a compound selected from Compounds (I) to (IV) is preferably carried out in the presence of a non-metallic polymerization initiator. For example, the compound can be polymerized in the presence of a polymerization initiator that generates free radicals such as carbon radicals or oxygen radicals by heating and thereby shows activity.

As the polymerization initiator, organic peroxides and organic azo compounds are preferred.

Preferred examples of the organic peroxides include ketone peroxides such as “PERHEXA H”, peroxyketals such as “PERHEXA TMH”, hydroperoxides such as “PERBUTYL H-69”, dialkylperoxides such as “PERCUMYL D”, “PERBUTYL C” and “PERBUTYL D”, diacyl peroxides such as “NYPER BW”, peroxy esters such as “PERBUTYL Z” and “PERBUTYL L”, and peroxy dicarbonates such as “PEROYL TCP” (each, trade name; commercially available from NOF Corporation), and “Luperox 11” (trade name; commercially available from ARKEMA YOSHITOMI).

Examples of the organic azo compound include azonitrile compounds such as “V-30”, “V-40”, “V-59”, “V-60”, “V-65” and “V-70”, azoamide compounds such as “VA-080”, “VA-085”, “VA-086”, “VF-096”, “VAm-110” and “VAm-111”, cyclic azoamidine compounds such as “VA-044” and “VA-061”, and azoamidine compounds such as “V-50” and “VA-057” (each, trade name; commercially available from Wako Pure Chemical Industries).

As the polymerization initiator, organic peroxides are preferred.

In the invention, these polymerization initiators may be used either singly or in combination.

The amount of the polymerization initiator to be used in the invention is preferably from 0.001 to 2 moles, more preferably from 0.05 to 1 mole, especially preferably from 0.01 to 0.5 mole, per mole of a monomer.

Examples of the adding method of the polymerization initiator to be used in the invention include batch addition, divided addition and continuous addition. Of these, batch addition and continuous addition are preferred because they enable preparation of a polymer having a high molecular weight even if the amount of the polymerization initiator is small.

For the polymerization reaction, any solvent is usable insofar as it can dissolve a compound selected from Compounds (I) to (IV) therein at a required concentration and does not adversely affect the properties of the film formed from the polymer thus obtained. Examples include water; alcohol solvents such as methanol, ethanol and propanol; ketone solvents such as acetone, methyl ethyl ketone, methyl isobutyl ketone, cyclohexanone and acetophenone; ester solvents such as methyl acetate, ethyl acetate, propyl acetate, isopropyl acetate, butyl acetate, pentyl acetate, hexyl acetate, methyl propionate, ethyl propionate, propylene glycol monomethyl ether acetate, γ-butyrolactone and methyl benzoate; ether solvents such as dibutyl ether, anisole and tetrahydrofuran; aromatic hydrocarbon solvents such as toluene, xylene, mesitylene, 1,2,4,5-tetramethylbenzene, pentamethylbenzene, isopropylbenzene, 1,4-diisopropylbenzene, t-butylbenzene, 1,4-di-t-butylbenzene, 1,3,5-triethylbenzene, 1,3,5-tri-t-butylbenzene, 4-t-butyl-orthoxylene, 1-methylnaphthalene and 1,3,5-triisopropylbenzene; amide solvents such as N-methylpyrrolidinone and dimethylacetamide; halogen solvents such as carbon tetrachloride, dichloromethane, chloroform, 1,2-dichloroethane, chlorobenzene, 1,2-dichlorobenzene and 1,2,4-trichlorobenzene; and aliphatic hydrocarbon solvents such as hexane, heptane, octane and cyclohexane. Of these solvents, preferred are the ester solvents, of which methyl acetate, ethyl acetate, propyl acetate, isopropyl acetate, butyl acetate, pentyl acetate, hexyl acetate, methyl propionate, ethyl propionate, propylene glycol monomethyl ether acetate, γ-butyrolactone, and methyl benzoate are more preferred, with ethyl acetate and butyl acetate being especially preferred.

These solvents may be used either singly or as a mixture of two or more.

When the solvent is the same, as the concentration of the compound selected from Compounds (I) to (IV) at the time of polymerization is smaller, a composition having a greater weight average molecular weight and a greater number average molecular weight and soluble in an organic solvent can be synthesized easily.

In this sense, the concentration of the compound selected from Compounds (I) to (IV) in the reaction mixture is preferably 30 mass % or less, more preferably 10 mass % or less, still more preferably 5 mass % or less.

The productivity at the time of the reaction is, on the other hand, better when the concentration of the compound selected from Compounds (I) to (IV) at the time of polymerization is higher. In this sense, the concentration of the compound selected from Compounds (I) to (IV) at the time of polymerization is preferably 0.1 mass % or greater, more preferably 1 mass % or greater.

The optimum conditions of the polymerization reaction in the invention differ, depending on the kind, concentration or the like of the polymerization initiator, monomer or solvent. The polymerization reaction is effected at a bulk temperature preferably from 0 to 200° C., more preferably from 40 to 170° C., especially preferably from 70 to 150° C. for a polymerization time preferably from 1 to 50 hours, more preferably from 2 to 20 hours, especially preferably from 3 to 10 hours.

The reaction is effected preferably in an inert gas atmosphere (for example, nitrogen or argon gas atmosphere) in order to suppress the inactivation of the polymerization initiator which will otherwise occur by oxygen. The oxygen concentration during the reaction is preferably 100 ppm or less, more preferably 50 ppm or less, especially preferably 20 ppm or less.

The weight average molecular weight (Mw) of the polymer available by the polymerization ranges preferably from 5,000 to 1,000,000, more preferably 20,000 to 800,000, especially preferably from 80,000 to 600,000.

The total amount of the polymerization product obtained by the reaction between compounds selected from Compounds (I) to (IV) accounts for preferably 60 mass % or greater, more preferably 80 mass % or greater, still more preferably 90 mass % or greater, most preferably 95 mass % or greater, each of the solid component in the composition of the invention.

The term “solid component” as used herein means a component that has remained after a volatile component is subtracted from all the components contained in the composition. The volatile component embraces a component that vaporizes after decomposition into a low molecular compound. Examples of the volatile component include water, organic solvent, thermally decomposable polymer and thermal desorption substituent.

Examples of the component contained in the solid content of the invention but other than the polymerization product obtained by the reaction of compounds selected from Compounds (I) to (IV) include a nonvolatile compound selected from Compounds (I) to (IV), a component contained in the copolymerization product containing the reaction product of a compound selected from Compounds (I) to (IV) but other than the reaction product of compounds (I) to (IV), and a nonvolatile additive.

The amount of the remaining compounds (I) to (IV) can be determined from the GPC chart, HPLC chart, NMR spectrum, UV spectrum, IR spectrum or the like of the solid component. The amount of the component in the copolymerization product can be sometimes determined from a charge ratio, but can also be determined from the NMR spectrum, UV spectrum, IR spectrum or elementary analysis of the solid component which has been purified in advance if necessary.

The nonvolatile additive can be quantitatively determined by a method using the addition amount of it as an amount present in the solid component or determined from the GPC chart or HPLC chart of the solid. It is also possible to determine the amount of the nonvolatile additive by purifying the solid component if necessary and then subjecting it to NMR spectrum, UV spectrum, IR spectrum or elementary analysis.

The polymerization product obtained by the reaction of compounds selected from Compounds (I) to (IV) is thus a remainder after subtraction of the above-described components from the solid component.

The composition of the invention is preferably soluble in an organic solvent. The term “soluble in an organic solvent” as used herein means that 5 mass % or greater, preferably 10 mass % or greater, more prefereably 20 mass % or greater, of the composition dissolves, at 25° C., in a solvent selected from cyclohexane, methyl ethyl ketone, methyl isobutyl ketone, propylene glycol monomethyl ether acetate, propylene glycol monomethyl ether and γ-butyrolactone.

When the composition of the invention contains a reaction product of compounds selected from Compounds (I) to (IV), the solid component in the composition of the invention has a GPC polystyrene-equivalent weight-average molecular weight (Mw) preferably within a range of from 5,000 to 1,000,000, more preferably from 20,000 to 800,000.

It is preferred that the Mw of a portion which has remained after removal of a compound monomer selected from Compounds (I) to (IV) from the GPC chart of the solid component contained in the composition of the invention is from 7,000 to 1,000,000, with from 25,000 to 800,000 being more preferred.

When the composition of the invention contains a reaction product of compounds selected from Compounds (I) to (IV), the solid component in the composition of the invention has a GPC polystyrene-equivalent number-average molecular weight (Mn) preferably within a range of from 1,000 to 300,000, more preferably from 3,000 to 250,000.

When the composition of the invention contains a reaction product of compounds selected from Compounds (I) to (IV), it is preferred that the Mn of a portion which has remained after removal of a compound selected from Compounds (I) to (IV) from the GPC chart of the solid component contained in the composition of the invention is from 3,000 to 3,000,000, with from 6,000 to 250,000 being more preferred.

The polymer (polymerization product) contained in the composition of the invention preferably does not substantially contain components having a molecular weight of 3,000,000 or greater, more preferably does not substantially contain components having a molecular weight of 2,000,000 or greater, most preferably does not contain components having a molecular weight of 1,000,000 or greater.

When the composition of the invention contains a reaction product of compounds selected from Compounds (I) to (IV), the amount of the compounds selected from Compounds (I) to (IV) and have remained unreacted, in the solid component contained in the composition of the invention, is preferably 40 mass % or less, more preferably 20 mass % or less, still more preferably 10 mass % or less, especially preferably 5 mass % or less, most preferably 2 mass % or less.

When the composition of the invention contains a reaction product of compounds selected from Compounds (I) to (IV), from 1 to 90 mole %, more preferably from 5 to 70 mole %, most preferably from 10 to 50 mole %, of the vinyl or ethynyl groups of the compounds selected from Compounds (I) to (IV) have remained unreacted in the solid component contained in the composition of the invention.

To the reaction product of compounds selected from Compounds (I) to (IV) in the composition of the invention, preferably from 0.1 to 40 wt. %, more preferably from 0.1 to 20 wt. %, still more preferably from 0.1 to 10 wt. %, most preferably from 0.1 to 5 wt. % of the polymerization initiator, additive or polymerization solvent may be bonded.

Amounts of them can be determined by the NMR spectrum or the like of the composition.

The composition having the above-described physical properties can be prepared by polymerizing a compound selected from Compounds (I) to (IV), while using high dilution conditions, adding a chain transfer agent, optimizing a reaction solvent, continuously adding a polymerization initiator, continuously adding the compound selected from Compounds (I) to (IV), adding a radical trapping agent, or the like.

It is also possible to filter off insoluble matters, purify by column chromatography, purify by re-precipitation treatment or the like after polymerization of a compound selected from Compounds (I) to (IV).

The term “re-precipitation treatment” as used herein means addition of a poor solvent (a solvent that does not substantially dissolve the composition of the invention therein) to the reaction mixture from which the reaction solvent has been distilled off as needed or dropwise addition of the reaction mixture from which the reaction solvent has been distilled off as needed to a poor solvent to precipitate the composition of the invention, followed by collection of it by filtration.

Preferred examples of the poor solvent include alcohols (such as methanol, ethanol, and isopropyl alcohol), and hydrocarbons (such as hexane and heptane). The poor solvent is added preferably in an amount of from equal mass to 200 times the mass, more preferably from 2 to 50 times the mass of the composition of the invention.

When the composition of the invention is prepared, the reaction mixture after polymerization reaction of a compound selected from Compounds (I) to (IV) may be used as is as the composition of the invention. It is however preferred to use, as the composition, the concentrate obtained by distilling off the reaction solvent and concentrating the residue. In addition, use after re-precipitation treatment is preferred.

The reaction mixture is concentrated preferably by heating and/or exposing it to vacuum in a rotary evaporator, distiller or the reaction apparatus used for the polymerization reaction. The temperature of the reaction mixture at the time of concentration is typically from 0 to 180° C., preferably from 10 to 140° C., more preferably from 20 to 100° C., most preferably from 30 to 60° C. The pressure at the time of concentration is typically from 0.001 to 760 torr, preferably from 0.01 to 100 torr, more preferably from 0.01 to 10 torr.

When the reaction mixture is concentrated, it is concentrated until the solid content in the reaction mixture reaches preferably 10 mass % or greater, more preferably 30 mass % or greater, most preferably 50 mass % or greater.

In the present invention, it is preferred that the polymer of a compound selected from Compounds (I) to (IV) is dissolved in an appropriate solvent and then the resulting solution is applied to a substrate. Examples of the usable solvent include ethylene dichloride, cyclohexanone, cyclopentanone, 2-heptanone, methyl isobutyl ketone, γ-butyrolactone, methyl ethyl ketone, methanol, ethanol, dimethylimidazolidinone, ethylene glycol monomethyl ether, ethylene glycol monoethyl ether, ethylene glycol dimethyl ether, 2-methoxyethyl acetate, ethylene glycol monoethyl ether acetate, propylene glycol monomethyl ether (PGME), propylene glycol monomethyl ether acetate (PGMEA), tetraethylene glycol dimethyl ether, triethylene glycol monobutyl ether, triethylene glycol monomethyl ether, isopropanol, ethylene carbonate, ethyl acetate, butyl acetate, methyl lactate, ethyl lactate, methyl methoxypropionate, ethyl ethoxypropionate, methyl pyruvate, ethyl pyruvate, propyl pyruvate, N,N-dimethylformamide, dimethylacetamide, dimethylsulfoxide, N-methylpyrrolidone, tetrahydrofuran, diisopropylbenzene, toluene, xylene, and mesitylene. These solvents may be used either singly or as a mixture.

Of these, preferred are propylene glycol monomethyl ether acetate, propylene glycol monomethyl ether, 2-heptanone, cyclohexanone, γ-butyrolactone, ethylene glycol monomethyl ether, ethylene glycol monoethyl ether, ethylene glycol monoethyl ether acetate, propylene glycol monomethyl ether, propylene glycol monoethyl ether, ethylene carbonate, butyl acetate, methyl lactate, ethyl lactate, methyl methoxypropionate, ethyl ethoxypropionate, N-methylpyrrolidone, N,N-dimethylformamide, tetrahydrofuran, methyl isobutyl ketone, xylene, mesitylene and diisopropylbenzene.

A solution obtained by dissolving the composition of the invention in an appropriate solvent is also embraced in the scope of the composition of the invention. A total solid concentration in the solution of the invention is preferably within a range of from 1 to 30 mass % and is regulated as needed according to the purpose of use. When the total solid concentration of the composition is within a range of from 1 to 30 mass %, the thickness of a coated film falls within an appropriate range, and a coating solution has better storage stability.

The composition of the invention may contain a polymerization initiator, but the composition not containing a polymerization initiator is preferred because it has better storage stability.

When the composition of the invention must be cured at a low temperature, however, it preferably contains a polymerization initiator. In such a case, polymerization initiators similar to those cited above can be employed. Also an initiator which induces polymerization by radiation may also be utilized for this purpose.

The content of metals, as an impurity, of the film forming composition of the invention is preferably as small as possible. The metal content of the film forming composition can be measured with high sensitivity by the ICP-MS and in this case, the content of metals other than transition metals is preferably 30 ppm or less, more preferably 3 ppm or less, especially preferably 300 ppb or less. The content of the transition metal is preferably as small as possible because it accelerates oxidation by its high catalytic capacity and the oxidation reaction in the prebaking or thermosetting process decreases the dielectric constant of the film obtained by the invention. The metal content is preferably 10 ppm or less, more preferably 1 ppm or less, especially preferably 100 ppb or less.

The metal concentration of the film forming composition can also be evaluated by subjecting a film obtained using the film forming composition of the invention to total reflection fluorescent X-ray analysis. When W ray is employed as an X-ray source, the metal concentrations of metal elements such as K, Ca, Ti, Cr, Mn, Fe, Co, Ni, Cu, Zn, and Pd can be measured. The concentrations of them are each preferably from 100×10¹⁰ atom·cm² or less, more preferably 50×10¹⁰ atom·cm⁻² or less, especially preferably 10×10¹⁰ atom·cm⁻² or less. In addition, the concentration of Br as a halogen can be measured. Its remaining amount is preferably 10000×10¹⁰ atom·cm⁻² or less, more preferably 1000×100 atom·cm⁻², especially preferably 400×10¹⁰ atom·cm⁻². Moreover, the concentration of Cl can also be observed as a halogen. In order to prevent it from damaging a CVD device, etching device or the like, itsremaining amount is preferably 100×10¹⁰ atom·cm⁻² or less, more preferably 50×10¹⁰ atom·cm⁻², especially preferably 10×10¹⁰ atom·cm⁻².

To the film forming composition of the invention, additives such as radical generator, colloidal silica, surfactant, silane coupling agent and adhesive agent may be added without impairing the properties (such as heat resistance, dielectric constant, mechanical strength, coatability, and adhesion) of an insulating film obtained using it.

Any colloidal silica may be used in the invention. For example, a dispersion obtained by dispersing high-purity silicic anhydride in a hydrophilic organic solvent or water and having usually an average particle size of from 5 to 30 nm, preferably from 10 to 20 nm and a solid concentration of from about 5 to 40 mass % can be used.

Any surfactant may be added in the invention. Examples include nonionic surfactants, anionic surfactants and cationic surfactants. Further examples include silicone surfactants, fluorosurfactants, polyalkylene oxide surfactants, and acrylic surfactants. In the invention, these surfactants can be used either singly or in combination. As the surfactant, silicone surfactants, nonionic surfactants, fluorosurfactants and acrylic surfactants are preferred, with silicone surfactants being especially preferred.

The amount of the surfactant to be used in the invention is preferably from 0.01 mass % or greater but not greater than 1 mass %, more preferably from 0.1 mass % or greater but not greater than 0.5 mass % based on the total amount of the film forming coating solution.

The term “silicone surfactant” as used herein means a surfactant containing at least one Si atom. Any silicone surfactant may be used in the invention, but it preferably has a structure containing an alkylene oxide and dimethylsiloxane, of which a silicone surfactant having a compound represented by the following chemical formula is more preferred:

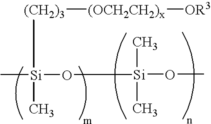

In the above formula, R³ represents a hydrogen atom or a C₁₋₅ alkyl group, x stands for an integer of from 1 to 20, and m and n each independently represents an integer of from 2 to 100. A plurality of R³ may be the same or different.

Examples of the silicone surfactant to be used in the invention include “BYK 306”, “BYK 307” (each, trade name; product of BYK Chemie), “SH7PA”, “SH21PA”, “SH28PA”, and “SH30PA” (each, trade name; product of Dow Corning Toray Silicone) and Troysol S366 (trade name; product of Troy Chemical).

As the nonionic surfactant to be used in the invention, any nonionic surfactant is usable. Examples include polyoxyethylene alkyl ethers, polyoxyethylene aryl ethers, polyoxyethylene dialkyl esters, sorbitan fatty acid esters, fatty-acid-modified polyoxyethylenes, and polyoxyethylene-polyoxypropylene block copolymers.

As the fluorosurfactant to be used in the invention, any fluorosurfactant is usable. Examples include perfluorooctyl polyethylene oxide, perfluorodecyl polyethylene oxide and perfluorododecyl polyethylene oxide.

As the acrylic surfactant to be used in the invention, any acrylic surfactant is usable. Examples include (meth)acrylic acid copolymer.

Any silane coupling agent may be used in the invention. Examples include 3-glycidyloxypropyltrimethoxysilane, 3-aminoglycidyloxypropyltriethoxysilane, 3-methacryloxypropyltrimethoxysilane, 3-glycidyloxypropylmethyldimethoxysilane, 1-methacryloxypropylmethyldimethoxysilane, 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-triethoxysilylpropyltriethylenetriamine, 10-trimethoxysilyl-1,4,7-triazadecane, 10-triethoxysilyl-1,4,7-triazadecane, 9-trimethoxysilyl-3,6-diazanonyl acetate, 9-triethoxysilyl-3,6-diazanonyl acetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, and N-bis(oxyethylene)-3-aminopropyltriethoxysilane. Those silane coupling agents may be used either singly or in combination. The silane coupling agent may be added preferably in an amount of 10 parts by weight or less, especially preferably from 0.05 to 5 parts by weight based on 100 parts by weight of the whole solid content.

In the invention, any adhesion accelerator may be used. Examples include trimethoxysilylbenzoic acid, γ-methacryloxypropyltrimethoxysilane, vinyltriacetoxysilane, vinyltrimethoxysilane, γ-isocyanatopropyltriethoxysilane, γ-glycidoxypropyltrimethoxysilane, β-(3,4-epoxycyclohexyl)ethyltrimethoxysilane, trimethoxyvinylsilane, γ-aminopropyltriethoxysilane, aluminum monoethylacetoacetate disopropylate, vinyltris(2-methoxyethoxy)silane, N-(2-aminoethyl)-3-aminopropylmethyldimethoxysilane, N-(2-aminoethyl)-3-aminopropyltrimethoxysilane, 3-chloropropylmethyldimethoxysilane, 3-chloropropyltrimethoxysilane, 3-methacryloxypropyltrimethoxysilane, 3-mercaptopropyltrimethoxysilane, trimethylchlorosilane, dimethylvinylchlorosilane, methyldiphenylchlorosilane, chloromethyldimethylchlorosilane, trimethylmethoxysilane, dimethyldiethoxysilane, methyldimethoxysilane, dimethylvinylethoxysilane, diphenyldimethoxysilane, phenyltriethoxysilane, hexamethyldisilazane, N,N′-bis(trimethylsilyl)urea, dimethyltrimethylsilylamine, trimethylsilylimidazole, vinyltrichlorosilane, benzotriazole, benzimidazole, indazole, imidazole, 2-mercaptobenzimidazole, 2-mercaptobenzothiazole, 2-mercaptobenzoxazole, urazole, thiourasil, mercaptoimidazole, mercaptopyrimidine, 1,1-dimethylurea, 1,3-dimethylurea and thiourea compounds. A functional silane coupling agent is preferred as an adhesion accelerator. The amount of the adhesion accelerator is preferably 10 parts by weight or less, especially preferably from 0.05 to 5 parts by weight, based on 100 parts by weight of the total solid content.

It is possible to add a pore forming factor to the composition of the invention to the extent allowed by the mechanical strength of a film in order to make a film porous and thereby reduce the dielectric constant thereof.

Although the pore forming factor which will be an additive serving as a pore forming agent is not particularly limited, non-metallic compounds are preferred. They must satisfy both solubility in the solvent used for a film forming coating solution and compatibility with the polymer of the invention.

A polymer may also be used as the pore forming agent. Examples of the polymer usable as the pore forming agent include aromatic polyvinyl compounds (such as polystyrene, polyvinylpyridine, and halogenated aromatic polyvinyl compound), polyacrylonitrile, polyalkylene oxides (such as polyethylene oxide and polypropylene oxide), polyethylene, polylactic acid, polysiloxane, polycaprolactone, polycaprolactam, polyurethane, polymethacrylates (such as polymethyl methacrylate), polymethacrylic acid, polyacrylates (such as polymethyl acrylate), polyacrylic acid, polydienes (such as polybutadiene and polyisoprene), polyvinyl chloride, polyacetal, amine-capped alkylene oxides, polyphenylene oxide, poly(dimethylsiloxane), polytetrahydrofuran, polycyclohexylethylene, polyethyloxazoline, polyvinylpyridine, and polycaprolactone.

Polystyrene is especially preferred as the pore forming agent. Examples of the polystyrene include anionically polymerized polystyrene, syndiotactic polystyrene and unsubstituted and substituted polystyrenes (such as poly(α-methylstyrene)), among which the non-substituted polystyrene is preferred.

Thermoplastic polymers may also be used as the pore forming agent. Examples of the thermoplastic pore-forming polymer include polyacrylate, polymethacrylate, polybutadiene, polyisoprene, polyphenylene oxide, polypropylene oxide, polyethylene oxide, poly(dimethylsiloxane), polytetrahydrofuran, polyethylene, polycyclohexylethylene, polyethyloxazoline, polycaprolactone, polylactic acid and polyvinylpyridine.

Such pore forming agent has a boiling point or decomposition point of preferably from 100 to 500° C., more preferably from 200 to 450° C., especially preferably from 250 to 400° C. The molecular weight thereof is preferably from 200 to 50,000, more preferably from 300 to 10,000, especially preferably from 400 to 5,000. The pore forming agent is added in an amount, in terms of mass % relative to the film-forming polymer, of preferably from 0.5 to 75%, more preferably from 0.5 to 30%, especially preferably from 1 to 20%.

The polymer may contain a decomposable group as a pore forming factor. The decomposition point thereof is preferably from 100 to 500° C., more preferably from 200 to 450° C., especially from 250 to 400° C. The content of the decomposable group is, in terms of mole % relative to the amount of the monomer in the film-forming polymer, preferably from 0.5 to 75%, more preferably from 0.5 to 30%, especially preferably from 1 to 20%.

The film forming composition of the invention is used for film formation preferably after elimination of insoluble matters, gel-like components and the like by filtration through a filter. A filter to be used for such a purpose preferably has a pore size of from 0.001 to 0.2 μm, more preferably from 0.005 to 0.05 μm, most preferably from 0.005 to 0.03 μm. The filter is made of preferably PTFE, polyethylene or nylon, more preferably polyethylene or nylon.

The film can be formed by applying the film forming composition of the invention onto a substrate by a desired method such as spin coating, roller coating, dip coating or scan coating, and then heating the substrate to remove the solvent. For drying off the solvent, the substrate is heated preferably for 0.1 to 10 minutes at from 40 to 250° C.

As the method of applying the composition to the substrate, spin coating and scan coating are preferred, with spin coating being especially preferred. For spin coating, commercially available apparatuses such as “Clean Track Series” (trade name; product of Tokyo Electron), “D-spin Series” (trade name; product of Dainippon Screen), or “SS series” or “CS series” (each, trade name; product of Tokyo Oka Kogyo) are preferably employed. The spin coating may be performed at any rotation speed, but from the viewpoint of in-plane uniformity of the film, a rotation speed of about 1300 rpm is preferred for a 300-mm silicon substrate.

When the solution of the composition is discharged, either dynamic discharge in which the solution is discharged onto a rotating substrate or static discharge in which the solution is discharged onto a static substrate may be employed. The dynamic discharge is however preferred in view of the in-plane uniformity of the film. Alternatively, from the viewpoint of reducing the consumption amount of the composition, a method of discharging only a main solvent of the composition to a substrate in advance to form a liquid film and then discharging the composition thereon can be employed. Although no particular limitation is imposed on the spin coating time, it is preferably within 180 seconds from the viewpoint of throughput. From the viewpoint of the transport of the substrate, it is preferred to subject the substrate to processing (such as edge rinse or back rinse) for preventing the film from remaining at the edge portion of the substrate. The heat treatment method is not particularly limited, but ordinarily employed methods such as hot plate heating, heating with a furnace, heating in an RTP (Rapid Thermal Processor) to expose the substrate to light of, for example, a xenon lamp can be employed. Of these, hot plate heating or heating with a furnace is preferred. As the hot plate, a commercially available one, for example, “Clean Track Series” (trade name; product of Tokyo Electron), “D-spin Series” (trade name; product of Dainippon Screen) and “SS series” or “CS series” (trade name; product of Tokyo Oka Kogyo) is preferred, while as the furnace, “a series” (trade name; product of Tokyo Electron) is preferred.

It is especially preferred to apply the polymer of the invention onto a substrate and then heating to cure it. For this purpose, the polymerization reaction, at the time of post heating, of a carbon-carbon double bond or a carbon-carbon triple bond remaining in the polymer may be utilized. The post heat treatment is performed preferably at from 100 to 450° C., more preferably at from 200 to 420° C., especially preferably at from 350 to 400° C., preferably for from 1 minute to 2 hours, more preferably for from 10 minutes to 1.5 hours, especially preferably for from 30 minutes to 1 hour. The post heat treatment may be performed in several times. This post heat treatment is performed especially preferably in a nitrogen atmosphere in order to prevent thermal oxidation due to oxygen.

In the invention, the polymer may be cured not by heat treatment but by exposure to high energy radiation to cause polymerization reaction of a carbon-carbon double bond or carbon-carbon triple bond remaining in the polymer. Examples of the high energy radiation include electron beam, ultraviolet ray and X ray. The curing method is not particularly limited to these methods.

When electron beam is employed as high energy radiation, the energy is preferably from 0 to 50 keV, more preferably from 0 to 30 keV, especially preferably from 0 to 20 keV. Total dose of electron beam is preferably from 0 to 5 μC/cm² or less, more preferably from 0 to 2 μC/cm², especially preferably from 0 to 1 μC/cm² or less. The substrate temperature when it is exposed to electron beam is preferably from 0 to 450° C., more preferably from 0 to 400° C., especially preferably from 0 to 350° C. Pressure is preferably from 0 to 133 kPa, more preferably from 0 to 60 kPa, especially preferably from 0 to 20 kPa. The atmosphere around the substrate is preferably an atmosphere of an inert gas such as Ar, He or nitrogen from the viewpoint of preventing oxidation of the polymer of the invention. An oxygen, hydrocarbon or ammonia gas may be added for the purpose of causing reaction with plasma, electromagnetic wave or chemical species which is generated by the interaction with electron beam. In the invention, exposure to electron beam may be carried out in plural times. In this case, the exposure to electron beam is not necessarily carried out under the same conditions but the conditions may be changed every time.

Ultraviolet ray may be employed as high energy radiation. The radiation wavelength range of the ultraviolet ray is preferably from 190 to 400 nm, while its output immediately above the substrate is preferably from 0.1 to 2000 mWcm⁻². The substrate temperature upon exposure to ultraviolet ray is preferably from 250 to 450° C., more preferably from 250 to 400° C., especially preferably from 250 to 350° C. The atmosphere around the substrate is preferably an atmosphere of an inert gas such as Ar, He or nitrogen from the viewpoint of preventing oxidation of the polymer of the invention. The pressure at this time is preferably from 0 to 133 kPa.

When the film obtained using the film forming composition of the invention is used as an interlayer insulating film for semiconductor, a barrier layer for preventing metal migration may be disposed on the side of an interconnect. In addition, a cap layer, an interlayer adhesion layer or etching stopping layer may be disposed on the upper or bottom surface of the interconnect or interlayer insulating film to prevent exfoliation at the time of CMP (Chemical Mechanical Polishing). Moreover, the layer of an interlayer insulating film may be composed of plural layers using another material as needed.

The film obtained using the film forming composition of the invention can be etched for copper interconnection or another purpose. Either wet etching or dry etching can be employed, but dry etching is preferred. For dry etching, either ammonia plasma or fluorocarbon plasma can be used as needed. For the plasma, not only Ar but also a gas such as oxygen, nitrogen, hydrogen or helium can be used. Etching may be followed by ashing for the purpose of removing a photoresist or the like used for etching. Moreover, the ashing residue may be removed by washing.

The film obtained using the film forming composition of the invention may be subjected to CMP for planarizing the copper plated portion after copper interconnection. As a CMP slurry (chemical solution), a commercially available one (for example, product of Fujimi Incorporated, Rodel Nitta, JSR or Hitachi Chemical) can be used as needed. As a CMP apparatus, a commercially available one (for example, product of Applied Material or Ebara Corporation) can be used as needed. After CMP, the film can be washed in order to remove the slurry residue.

The film available using the film forming composition of the invention can be used for various purposes. For example, it is suited for use as an insulating film in semiconductor devices such as LSI, system LSI, DRAM, SDRAM, RDRAM and D-RDRAM, and in electronic devices such as multi-chip module multi-layered wiring board. It can also be used as a passivation film or an α-ray shielding film for LSI, a coverlay film for flexographic printing plate, an overcoat film, a cover coating for a flexible copper-clad board, a solder resist film, and a liquid crystal alignment film as well as an interlayer insulating film for semiconductor, a metal diffusion barrier film, an etching stopper film, a surface protective film, and a buffer coating film. Moreover, it can be used as a surface protective film, antireflective film and phase difference film for optical devices.

An insulating film having a low dielectric constant, more specifically, a specific dielectric constant of 2.9 or less, preferably 2.7 or less can be obtained by the above-described process.

### EXAMPLES

The invention will hereinafter be described further by Examples and Comparative Examples. It should however be borne in mind that the present invention is not limited to or by them.

### Synthesis Example 1

Exemplary compound (I-a) (500 mg) was added to 10 ml ofbutyl acetate. In a nitrogen gas stream, “Lupasol 11” (trade name; product of ARKEMA YOSHITOMI) was added to the resulting mixture every one hour in 5 μl portions, 5 times in total, while heating under reflux. Heating under reflux was continued for further 1 hour. After cooling to room temperature, the reaction mixture was concentrated under reduced pressure. To the residue was added 20 ml of methanol. After stirring one hour, a solid matter was collected by filtration and dried to yield 200 mg of a solid component. GPC analysis of the solid component resulted in Mw of 20,100 and Mn of 4,300. In the solid, 1 mass % or less of the starting substance remained unreacted. The GPC was conducted utilizing Waters 2695 and GPC column manufactured by Shodex. A calibration curve for the monomer was prepared utilizing an integrated value of an RI detecting apparatus (Waters 2414) to determined the amount of the monomer in the solid component. The Mn and Mw were calculated using the calibration curve constructed with standard polystyrene.

When 1.2 ml of cyclohexanone was added to 100 mg of the composition and the resulting mixture was stirred at 40° C. for 3 hours, a uniform solution was obtained.

As a surfactant, 2 μl of “BYK306” (product of BYK CHEMIE) was added, whereby a composition (I-a-1) of the invention was obtained. It is apparent from the weight of the remaining monomer and weight of the additive, the polymerization product obtained by the reaction of vinyl groups of the monomer accounts for 60 mass % or greater of the solid component in the composition (I-a-1).

### Synthesis Example 2

Exemplary compound (II-a) (2 g) was added to 400 ml of ethyl acetate. In a nitrogen gas stream, “Lupasol 11” (trade name; product of ARKEMA YOSHITOMI) was added to the resulting mixture every one hour in 10 μl portions, 4 times in total, while heating under reflux. Heating under reflux was continued for further 1 hour. After cooling to room temperature, the reaction mixture was concentrated under reduced pressure. To the residue was added 60 ml of methanol. After stirring for one hour, a solid matter was collected by filtration and dried to yield 0.92 g of a solid component. GPC analysis of the solid component resulted in Mw of 25,900 and Mn of 4,600. In the solid, 1 mass % or less of the starting substance remained unreacted. When 11 ml of cyclohexanone was added to the composition and the resulting mixture was stirred at 40° C. for 3 hours, a uniform solution was obtained. As a surfactant, 11 μl of “BYK306” was added, whereby a composition (II-a-1) of the invention was obtained.

It is apparent from the mass of the remaining monomer and the mass of the additive, the polymerization product obtained by the reaction of vinyl groups of the monomer accounts for 60 mass % or greater of the solid component in the composition.

### Synthesis Example 3

Exemplary compound (III-b) (3 g) was added to 30 ml of ethyl acetate. In a nitrogen gas stream, “Lupasol 11” (trade name; product of ARKEMA YOSHITOMI) was added to the resulting mixture every one hour in 10 μl portions, 4 times in total, while heating under reflux. Heating under reflux was continued for further 1 hour. After cooling to room temperature, the reaction mixture was concentrated under reduced pressure. To the residue was added 70 ml of methanol. After stirring for one hour, a solid matter was collected by filtration and dried to yield 1.58 g of a solid component. GPC analysis of the solid component resulted in Mw of 33,100 and Mn of 5,100. In the solid, 1 mass % or less of the starting substance remained unreacted. When 18 ml of cyclohexanone was added to the composition and the mixture was stirred at 40° C. for 3 hours, a uniform solution was obtained. As a surfactant, 18 μl of “BYK306” was added, whereby a composition (III-b-1) of the invention was obtained.

It is apparent from the mass of the remaining monomer and the mass of the additive, the polymerization product obtained by the reaction of vinyl groups of the monomer accounts for 60 mass % or greater of the solid component in the composition.

### Synthesis Example 4

Exemplary compound (IV-a) (1 g, product of Aldrich) was added to 20 g of butyl acetate. “Lupasol 11” (trade name; product of ARKEMA YOSHITOMI) was added to the resulting mixture every one hour in 1 μl portions, 3 times in total, while heating under reflux. Heating under reflux was continued for further 1 hour. After cooling to room temperature, the reaction mixture was concentrated under reduced pressure. To the residue was added 20 ml of methanol. After stirring one hour, a solid matter was collected by filtration and dried to yield 0.88 g of a solid component. GPC analysis of the solid component resulted in Mw of 43,100 and Mn of 5,100. In the solid, 4 mass % or less of the starting substance remained unreacted. When 5 ml of propylene glycol methyl ether acetrate was added to 0.3 g of the composition and the resulting mixture was stirred at 40° C. for 3 hours, a uniform solution was obtained. As a surfactant, 5 μl of “BYK306” was added, whereby a composition (IV-a-1) of the invention was obtained.

### Synthesis Example 5

Exemplary compound (III-e) (1 g) was added to 6 ml of butyl acetate. “Lupasol 11” (trade name; product of ARKEMA YOSHITOMI) was added to the resulting mixture every one hour in 20 μl portions, 5 times in total, while heating under reflux. Heating under reflux was continued for further 1 hour. After cooling to room temperature, the reaction mixture was concentrated under reduced pressure. To the residue was added 40 ml of methanol. After stirring one hour, a solid matter was collected by filtration and dried to yield 210 mg of a solid component. GPC analysis of the solid component resulted in Mw of 27,100 and Mn of 3,100. In the solid, 1 mass % or less of the starting substance remained unreacted. When 4 ml of cyclohexanone was added to 0.3 g of the composition and the mixture was stirred at 40° C. for 3 hours, a uniform solution was obtained. As a surfactant, 4 μl of “BYK306” was added, whereby a composition (III-e-1) of the invention was obtained.

The compositions of the invention prepared in the above-described Synthesis Examples were, after filtration through a filter made of Teflon (trade mark) and having a 0.2 μm pore size, each applied onto a 4-inch silicon wafer by spin coating. The substrate was then dried at 130° C. for 1 minute and then at 200° C. for one minute on a hot plate. It was heated at 400° C. for 30 minutes in a clean oven under a nitrogen atmosphere, whereby a film was formed.

<Evaluation of Dielectric Constant>

The dielectric constant was measured using a mercury probe manufactured by Four Dimensions (measured at 25° C.).

<Evaluation of Etch Selectivity>

Etching was conducted under etching conditions for inorganic interlayer insulating films (with a gas species composed mainly of fluorocarbon, which will hereinafter be called “inorganic system etching conditions”) and a film thickness FT_{A} etched per hour was measured using a film thickness meter. Under similar inorganic system etching conditions, a PECVD-SiOC film was etched and a film thickness FT_{B} etched per hour was measured using a film thickness meter. The FT_{B}/FT_{A} at this time was defined as an etch selectivity A under inorganic system etching conditions.

Etching of the etching stopper film thus obtained was etched under etching conditions for organic interlayer insulating films (with a gas species composed mainly of ammonia, which will hereinafter be called “organic system etching conditions”) and the film thickness FT_{C} etched per hour was measured by a film thickness meter. Under similar organic system etching conditions, an organic polymer interlayer insulating film obtained from the coating solution of the invention was etched and the film thickness FT_{D} etched per hour was measured. At this time, (FT_{D}/FT_{C}) was defined as etch selectivity B under organic system etching conditions.

Evaluation results are shown in Table 1.

TABLE 1

| | Specific | Etch | Etch |
|---|---|---|---|
| Composition | dielectric constant | selectivity A | selectivity B |
| I-a-1 | 2.59 | 10.1 | 6.0 |
| II-a-1 | 2.69 | 8.9 | 6.5 |
| III-b-1 | 2.64 | 8.2 | 6.6 |
| IV-a-1 | 2.51 | 6.3 | 7.8 |
| III-e-1 | 2.70 | 8.5 | 8.0 |

The contents of metal atoms contained in the composition of the invention were all 10 ppb or less.

The results shown in Table 1 have revealed that use of the composition of the invention makes it possible to form a film having a low dielectric constant, having a high etch selectivity relative to a low-k film, and having a small metal content.

The present invention makes it possible to provide an insulating film suited for use as an interlayer insulating film in semiconductor devices and the like, having an adequately uniform thickness, excellent in film properties such as dielectric constant and Young's modulus of elasticity, and excellent in etch selectivity and metal diffusion barrier properties; and also an interlayer insulating film for use in semiconductor devices.

The entire disclosure of each and every foreign patent application from which the benefit of foreign priority has been claimed in the present application is incorporated herein by reference, as if fully set forth.

What is claimed is:

1. A composition comprising:
at least one kind polymer, each of which comprises a repeating unit(s) derived from at least one compound selected from the group consisting of compounds represented by the following formulas (I) to (IV):
R₄Si (I)
wherein each of Rs represents a nonhydrolyzable group, with the proviso that each of at least two of Rs represents a group comprising vinyl group or ethynyl group;
R₃Si—(X—SiR₂)ₘ—X—Si—R₃ (II)
wherein each of Rs represents a nonhydrolyzable group, with the proviso that each of at least two of Rs represents a group comprising vinyl group or ethynyl group,
m represents an integer of 0 or greater, and
X represents —O—, —NR¹—, an alkylene group or a phenylene group in which R¹ represents a hydrogen atom or a substituent;
*—(X—SiR₂)ₙ—* (III)
wherein each of Rs represents a nonhydrolyzable group, with the proviso that each of at least two of Rs represents a group comprising vinyl group or ethynyl group,
X represents —O—, —NR¹—, an alkylene group or a phenylene group in which R¹ represents a hydrogen atom or a substituent,
n represents an integer of 2 to 16, and
*s are bonded to each other to form a ring; and
m.RSi(O_{0.5})₃ (IV)
wherein the formula (IV) represents a compound that has m pieces of RSi(O_{0.5})₃ units, each of which links with other units by sharing the oxygen atoms so as to form a cage structure,
m represents an integer of 8 to 16,
each of Rs represents a nonhydrolyzable group, with the proviso that each of at least two of Rs represents a group comprising vinyl group or ethynyl group.

2. The composition according to claim 1,
wherein each of at least two of Rs in each of the formulas (I) to (IV) represents a vinyl group.

3. The composition according to claim 1,
wherein an amount of a polymer which is obtained by reaction between vinyl groups is 60 mass % or greater of solid components in the composition.

4. The composition according to claim 1,
wherein the at least one kind polymer comprises a polymer which is obtained by radical polymerization.

5. The composition according to claim 1, which is soluble in an organic solvent.

6. The composition according to claim 1, further comprising:
an organic solvent.

7. The composition according to claim 1, further comprising:
a surfactant.

8. A film forming composition, comprising:
the composition according to claim 1.

9. An insulating film forming composition, comprising:
the composition according to claim 1.

10. An etching stopper film forming composition, comprising:
the composition according to claim 1.

11. A metal diffusion barrier film forming composition, comprising:
the composition according to claim 1.

12. A production method of film, comprising:
a process of applying the film forming composition according to claim 8 onto a substrate;
a process of film-hardening.

13. A film produced by the production method according to claim 12.

14. A semiconductor device comprising:
the film according to claim 13.
